(19) United States
(12) Patent Application Publication
(10) Pub. No.: US 2002/0002631 A1
(43) Pub. Date: Jan. 3, 2002

(54) Enhanced channel adapter

(75) Inventors: Jens Haulund, Trumbull, CT (US); Graham G. Yarbrough, Sandy Hook, CT (US)

Correspondence Address: Leo R. Reynolds, Esq., HAMILTON, BROOK, SMITH & REYNOLDS, P.C., Two Militia Drive, Lexington, MA, 02421-4799, US

(73) Assignee: INRANGE Technologies Corporation, Lumberton, NJ (US)

(21) Appl. No.: 09/872,778

(22) Filed: Jun. 1, 2001

Related U.S. Application Data
(60) Provisional application No. 60/209,054, filed on Jun. 2, 2000.
(60) Provisional application No. 60/209,173, filed on Jun. 2, 2000.

(51) Int. Cl. G06F 9/46

(52) U.S. Cl. 709/314

(57) ABSTRACT

The system comprises a first processor, a second processor and non-volatile memory. The non-volatile memory stores messages being transferred between the first and second processors. The non-volatile memory is resettably and logically decoupled from first and second processors to preserve the state of the first and second processors and the messages in the event of a loss of communication or a processor reset. The non-volatile memory increases the rate of message transfer by transferring blocks of messages between the non-volatile memory and the second processor. The non-volatile memory includes status and control registers to store the state of messages being transferred, message queues, and first and second processors. The system may also include a local power source to provide power to the non-volatile memory.

### RELATED APPLICATION(S)

This application claims the benefit of U.S. Provisional Application No. 60/209,054, filed Jun. 2, 2000, entitled “Enhanced EET-3 Channel Adapter Card,” by Haulund et al.; U.S. Provisional Patent Application No. 60/209,173, filed Jun. 2, 2000, entitled “Message Director,” by Yarbrough; and is related to co-pending U.S. Patent Application, filed concurrently herewith, Attorney Docket No. 2997.1004-001, entitled “Message Queue Server System” by Yarbrough; the entire teachings of all are incorporated herein by reference.

### BACKGROUND OF THE INVENTION

Today's computing networks, such as the Internet, have become so widely used, in part, because of the ability for the various computers connected to the networks to share data. These networks and computers are often referred to as “open systems” and are capable of sharing data due to commonality among the data handling protocols supported by the networks and computers. For example, a server at one end of the Internet can provide airline flight data to a personal computer in a consumer's home. The consumer can then make flight arrangements, including paying for the flight reservation, without ever having to speak with an airline agent or having to travel to a ticket office. This is but one scenario in which open systems are used.

One type of computer system that has not “kept up with the times” is the mainframe computer. A mainframe computer was at one time considered a very sophisticated computer, capable of handling many more processes and transactions than the personal computer. Today, however, because the mainframe computer is not an open system, its processing abilities are somewhat reduced in value since legacy data that are stored on tapes and read by the mainframes via tape drives are unable to be used by open systems. In the airline scenario discussed above, the airline is unable to make the mainframe data available to consumers.

FIG. 1 illustrates a present day environment of the mainframe computer. The airline, Airline A, has two mainframes, a first mainframe 1a (Mainframe A) and a second mainframe 1b (Mainframe B). The mainframes may be in the same room or may be separated by a building, city, state or continent.

The mainframes 1a and 1b have respective tape drives 5a and 5b to access and store data on data tapes 15a and 15b corresponding to the tasks with which the mainframes are charged. Respective local tape storage bins 10a and 10b store the data tapes 15a, 15b.

During the course of a day, a technician 20a servicing Mainframe A loads and unloads the data tapes 15a. Though shown as a single tape storage bin 10a, the tape storage bin 10a may actually be an entire warehouse full of data tapes 15a. Thus, each time a new tape is requested by a user of Mainframe A, the technician 20a retrieves a data tape 15a and inserts it into tape drive 5a of Mainframe A.

Similarly, a technician 20b services Mainframe B with its respective data tapes 15b. In the event an operator of Mainframe A desires data from a Mainframe B data tape 15b, the second technician 20b must retrieve the tape and send it to the first technician 20a, who inserts it into the Mainframe A tape drive 5a. If the mainframes are separated by a large distance, the data tape 15b must be shipped across this distance and is then temporarily unavailable by Mainframe B.

FIG. 2 is an illustration of a prior art channel-to-channel adapter 25 used to solve the problem of data sharing between Mainframes A and B that reside in the same location. The channel-to-channel adapter 25 is in communication with both Mainframes A and B. In this scenario, it is assumed that Mainframe A uses an operating system having a first protocol, protocol A, and Mainframe B uses an operating system having a second protocol, protocol B. It is further assumed that the channel-to-channel adapter 25 uses a third operating system having a third protocol, protocol C. The adapter 25 negotiates communications between Mainframes A and B. Once the negotiation is completed, the Mainframes A and B are able to transmit and receive data with one another according to the rules negotiated.

In this scenario, all legacy applications operating on Mainframes A and B have to be rewritten to communicate with the protocol of the channel-to-channel adapter 25. The legacy applications may be written in relatively archaic programming languages, such as COBOL. Because many of the legacy applications are written in older programming languages, the legacy applications are difficult enough to maintain, let alone upgrade, to use the channel-to-channel adapter 25 to share data between the mainframes.

Another type of adapter used to share data among mainframes or other computers in heterogeneous computing environments is described in U.S. Pat. No. 6,141,701, issued Oct. 31, 2000, entitled “System for, and Method of, Off-Loading Network Transactions from a Mainframe to an Intelligent Input/Output Device, Including Message Queuing Facilities,” by Whitney. The adapter described by Whitney is a message oriented middleware system that facilitates the exchange of information between computing systems with different processing characteristics, such as different operating systems, processing architectures, data storage formats, file subsystems, communication stacks, and the like. Of particular relevance is the family of products known as “message queuing facilities” (MQF). Message queuing facilities help applications in one computing system communicate with applications in another computing system by using queues to insulate or abstract each other's differences. The sending application “connects” to a queue manager (a component of the MQF) and “opens” the local queue using the queue manager's queue definition (both the “connect” and “open” are executable “verbs” in a message queue series (MQSeries) application programming interface (API). The application can then “put” the message on the queue.

Before sending a message, an MQF typically commits the message to persistent storage, typically to a direct access storage device (DASD). Once the message is committed to persistent storage, the MQF sends the message via the communications stack to the recipient's complementary and remote MQF. The remote MQF commits the message to persistent storage and sends an acknowledgment to the sending MQF. The acknowledgment back to the sending queue manager permits it to delete the message from the sender's persistent storage. The message stays on the remote MQF's persistent storage until the receiving application indicates it has completed its processing of it. The queue definition indicates whether the remote MQF must trigger the receiving application or if the receiver will poll the queue on its own. The use of persistent storage facilitates recoverability. This is known as “persistent queue.”

Eventually, the receiving application is informed of the message in its local queue (i.e., the remote queue with respect to the sending application), and it, like the sending application, “connects” to its local queue manager and “opens” the queue on which the message resides. The receiving application can then execute “get” or “browse” verbs to either read the message from the queue or just look at it.

When either application is done processing its queue, it is free to issue the “close” verb and “disconnect” from the queue manager.

The persistent queue storage used by the MQF is logically an indexed sequential data set file. The messages are typically placed in the queue on a first-in, first-out (FIFO) basis, but the queue model also allows indexed access for browsing and the direct access of the messages in the queue.

Though MQF is helpful for many applications, current MQF and related software utilize considerable mainframe resources. Moreover, modern MQF's have limited, if any, functionality allowing shared queues to be supported.

Another type of adapter used to share data among mainframes or other computers in heterogeneous computing environments is described in U.S. Pat. No. 5,906,658, issued May 25, 1999, entitled “Message Queuing on a Data Storage System Utilizing Message Queueing in Intended Recipient's Queue,” by Raz. Raz provides, in one aspect, a method for transferring messages between a plurality of processes that are communicating with a data storage system, wherein the plurality of processes access the data storage system by using I/O services. The data storage system is configured to provide a shared data storage area for the plurality of processes, wherein each of the plurality of processes is permitted to access the shared data storage region.

### SUMMARY OF THE INVENTION

In U.S. Pat. No. 6,141,701, Whitney addresses the problem that current MQF (message queuing facilities) and related software utilize considerable mainframe resources and costs associated therewith. By moving the MQF and related processing from the mainframe processor to an I/O adapter device, the I/O adapter device performs a conventional I/O function, but also includes MQF software, a communications stack, and other logic. The MQF software and the communications stack on the I/O adapter device are conventional.

Whitney further provides logic effectively serving as an interface to the MQF software. In particular, the I/O adapter device of Whitney includes a storage controller that has a processor and a memory. The controller receives I/O commands having corresponding addresses. The logic is responsive to the I/O commands and determines whether an I/O command is within a first set of predetermined I/O commands. If so, the logic maps the I/O command to a corresponding message queue verb and queue to invoke the MQF. From this, the MQF may cooperate with the communications stack to send and receive information corresponding to the verb.

The problem with the solution offered by Whitney is similar to that of the adapter 25 (FIG. 2) in that the legacy applications of the mainframe must be rewritten to use the protocol of the MQF. This causes a company, such as an airline, that is not in the business of maintaining and upgrading legacy software to expend resources upgrading the mainframes to work with the MQF to communicate with today's open computer systems and to share data even among their own mainframes, which does not address the problems encountered when mainframes are located in different cities.

The problem with the solution offered in U.S. Pat. No. 5,906,658 by Raz is, as in the case of Whitney, legacy applications on mainframes must be rewritten in order to allow the plurality of processes to share data.

The present invention is used in a message queue server that addresses the issue of having to rewrite legacy applications in mainframes by using the premise that mainframes have certain peripheral devices, as described in related U.S. Patent application filed concurrently herewith, Attorney Docket No. 2997.1004-001, entitled “Message Queue Server System” by Graham G. Yarbrough, the entire contents of which are incorporated herein by reference. The message queue server emulates a tape drive that not only supports communication between two mainframes, but also provides a gateway to open systems computers, networks, and other similar message queue servers. In short, the message queue server provides protocol-to-protocol conversion from mainframes to today's computing systems in a manner that does not require businesses that own the mainframes to rewrite legacy applications to share data with other mainframes and open systems. The present invention improves such a message queue server by ensuring message recoverability in the event of a system reset or loss of communication and providing efficient message transfer within the message queue server.

The present invention provides a system and method for transferring messages in a message queue server. The system comprises a first processor, non-volatile memory and a second processor. The non-volatile memory is in communication with the first and second processors. The non-volatile memory stores messages being transferred between the first and second processors. A message being transferred is maintained in the non-volatile memory until specifically deleted or the non-volatile memory is intentionally reset. The non-volatile memory is resettably and logically decoupled from the first and second processors to ensure message recoverability in the event that the second processor experiences a loss of communication with the non-volatile memory.

The non-volatile memory typically maintains system states, including the state of message transfer between the first and second processors, state of first and second processors, and state of message queues.

In one embodiment, the non-volatile memory receives and stores messages from the first processor on a single message by single message basis. The second processor transfers messages from the non-volatile memory in blocks of messages. The rate of message transfer in blocks of messages is as much as five times faster than on a single message by single message basis.

A special circuit or relay can be provided to decouple the non-volatile memory from the first and second processors in the event that the first or second processor resets. The system can also include a sensor for detecting a loss of power or processor reset to store the state of message transfer at the time of the detected interruption. Thus, the non-volatile memory preserves the messages and system states after a processor reset or loss of communication to ensure message recoverability.

In one embodiment, the system has a plurality of second processors. Each second processor can have independent access to the message queues in the non-volatile memory. Further, each second processor can be brought on-line and off-line at any time to access the non-volatile memory. The plurality of second processors can have access to the same queues. One or more second processors may access the same queue at different times. Further, a subset of messages in the same queue can be accessed by one or more second processors.

The system can also include a local power source, such as a battery, to provide power to the non-volatile memory for at least 2 minutes or at least 30 seconds to maintain messages and system states until communication is reestablished or power recovers. Thus, in a startup after a power failure or loss of communication, the second processor examines the non-volatile memory to reestablish communication without the loss or doubling of messages.

In another embodiment of the present invention, an adapter card includes a first processor and non-volatile memory. The adapter card may be attached to the backplane of a message transfer unit.

By resettably and logically decoupling the non-volatile memory from the first and second processors and using a local power source, the adapter card allows for persistent message storage in the event of a system reset or loss of communication while also providing efficient message transfer between the first and second processors.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of an environment in which mainframe computers are used with computer tapes to share data among the mainframe computers;

FIG. 2 is a block diagram of a prior art solution to sharing data between mainframes without having to physically transport tapes between the mainframes, as in the environment of FIG. 1;

FIG. 3 is an illustration of a message transfer unit of the present invention having a plurality of first and second processors and non-volatile memory;

FIG. 4 is a block diagram depicting message transfers among the components of the message transfer unit of FIG. 3;

FIG. 5 is a block diagram of an adapter of the present invention having a first processor and non-volatile memory;

FIG. 6 is a flow diagram of a message recovery process executed by the adapter card of FIG. 5;

FIGS. 7A and 7B are flow diagrams of a message queue transfer process executed by the adapter card of FIG. 5; and

FIG. 8 is a flow diagram of a memory reset process executed by the adapter card FIG. 5.

### DETAILED DESCRIPTION OF THE INVENTION

A description of preferred embodiments of the invention follows.

A message transfer unit (MTU) is used to transfer messages from mainframes to other systems by emulating a mainframe peripheral device, such as a tape drive. In typical tape drive manner, the messages being transferred are stored in queues. In this way, legacy application executed by the mainframe believe that they are merely storing data or messages on a tape or reading data or messages from a tape, as described in related U.S. Patent application filed concurrently herewith, Attorney Docket No. 2997.1004-001, entitled “Message Queue Server System” by Graham G. Yarborough, the entire contents of which are incorporated herein by reference. Within the message transfer unit, there is at least one adapter card that is connected to respective communication link(s), which are connected to at least one mainframe. The adapter card receives/transmits messages from/to the mainframe(s) on a single-message by single-message basis. The messages inside the message transfer unit are transferred between the adapter card and memory.

The principles of the present invention improve message transfer rates within the message transfer unit by allowing blocks of messages to be transferred within the MTU, rather than being transferred on a single-message by single-message basis, as is done, between the message transfer unit and the mainframe(s). The principles of the present invention also ensure message recoverability after a system reset or loss of communication by storing messages and the status of MTU devices, including the adapter, on non-volatile memory. This is shown and discussed in detail below.

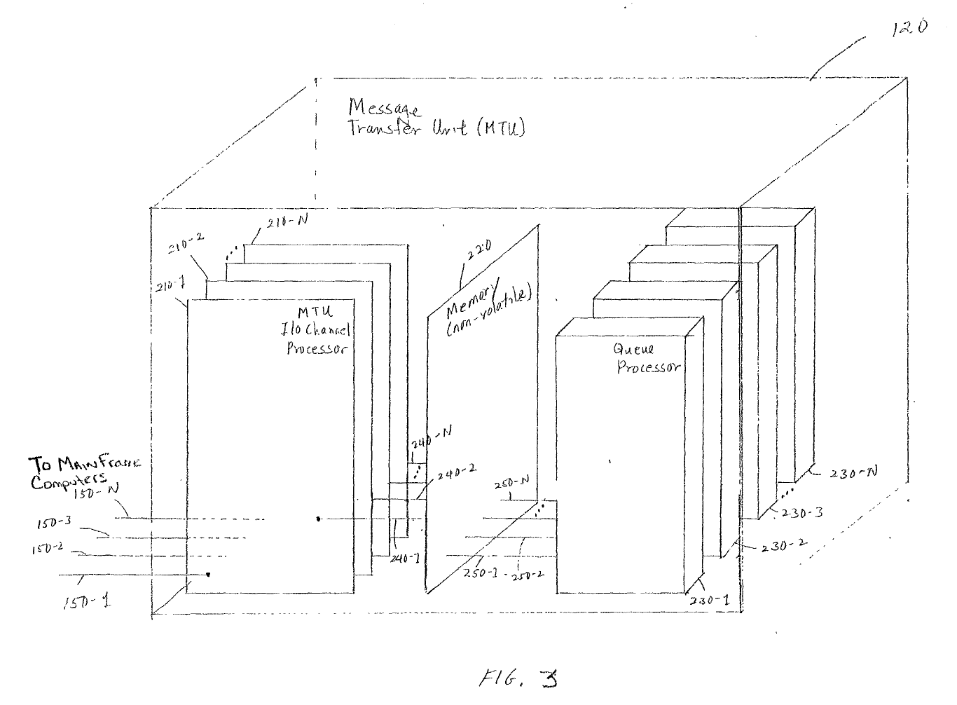

Referring now to FIG. 3, the MTU 120 includes a plurality of first processors 210-1, 210-2, 210-3, . . . 210-N, second processors 230-1, 230-2, . . . 230-N, and non-volatile memory 220. Also included are communication links 150-1, 150-2, 150-3, . . . 150-N, first data buses 240-1, 240-2, 240-3, . . . 240-N, and second data buses 250-1, 250-2, 250-3, . . . 250-N.

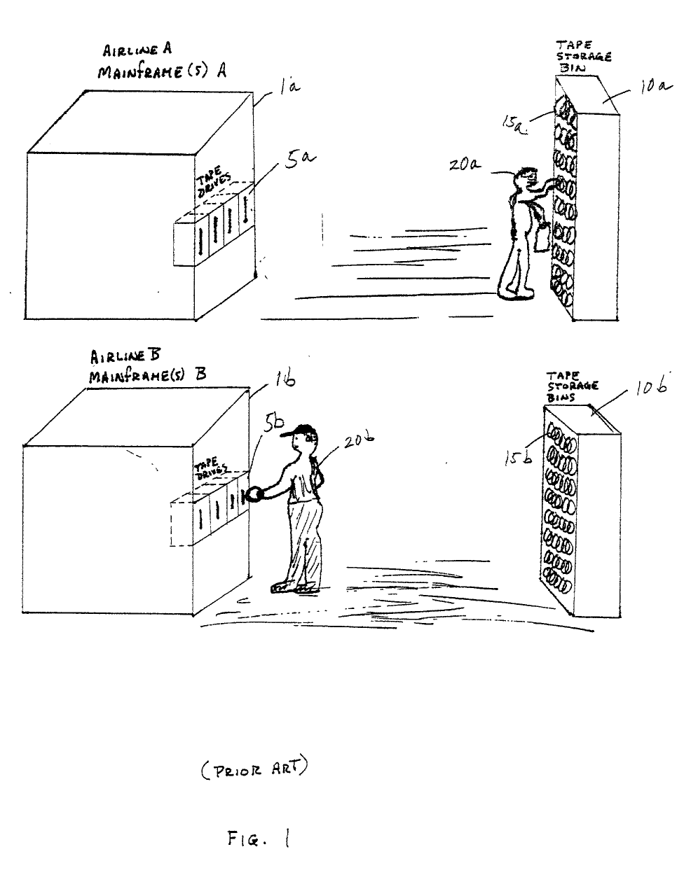

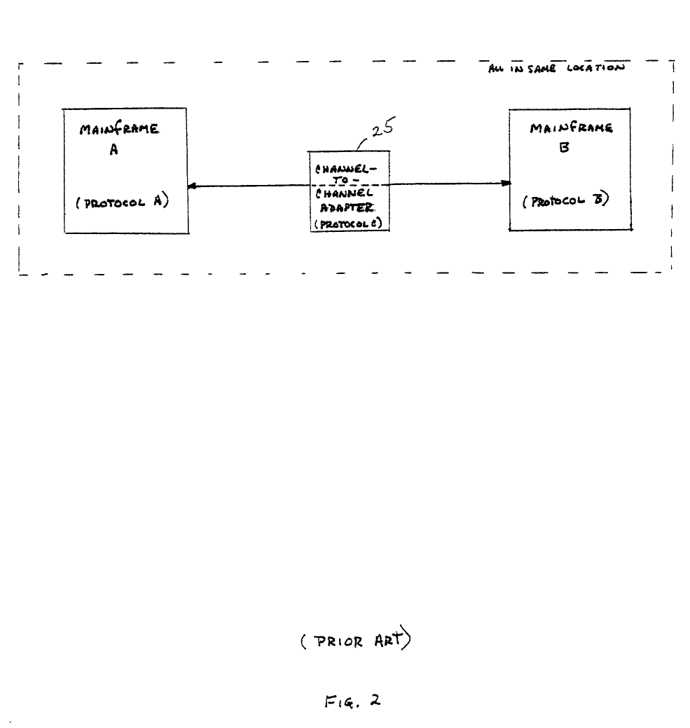

The first processors 210 may be MTU I/O channel processors, such as Enterprise Systems Connection (ESCON®) channel processors. Each I/O channel processor 210 performs I/O operations and executes message transfers to/from a mainframe system using a first data protocol. Each I/O channel processor 210 uses an associated communication link 150 to communicate with a mainframe computer (FIG. 1). The communication links 150 may be fibre optic links, transferring messages at a rate of about 200 megabits/sec.

The first data buses 240 are used to transfer messages between the first processors 210 and non-volatile memory 220. The first data buses 240 may be a shared bus.

The non-volatile memory 220 is coupled to the I/O channel processors 210 and second processors 230. The non-volatile memory 220 should have a capacity of about 2 gigabytes or more to store messages being transferred between the I/O channel processors 210 and second processor 230. In addition, the non-volatile memory 220 is shareable and may be accessed by the I/O channel processors 210 and second processors 230.

The second data buses 250 are used to transfer message between the non-volatile memory 220 and second processors 210. Similar to the first data buses, the second data buses 250 also may be a shared bus.

The second processors 230 may be message queue processors. The queue processors 230 include messaging middleware queues. When all the messages in a message queue 320 are received from the non-volatile memory 220 in a messaging middleware queue, the completion of the queue is indicated by an end of tape marker as discussed in related U.S. patent application filed concurrently herewith, entitled “Message Queue Server System” by Graham G. Yarbrough, the entire principles of which are incorporated herein by reference. In addition, the queue processors 230 have access to the non-volatile memory 220. Although not shown in FIG. 3, it is understood that one or more queue processors 230 may share the same queue of messages stored in the memory 220.

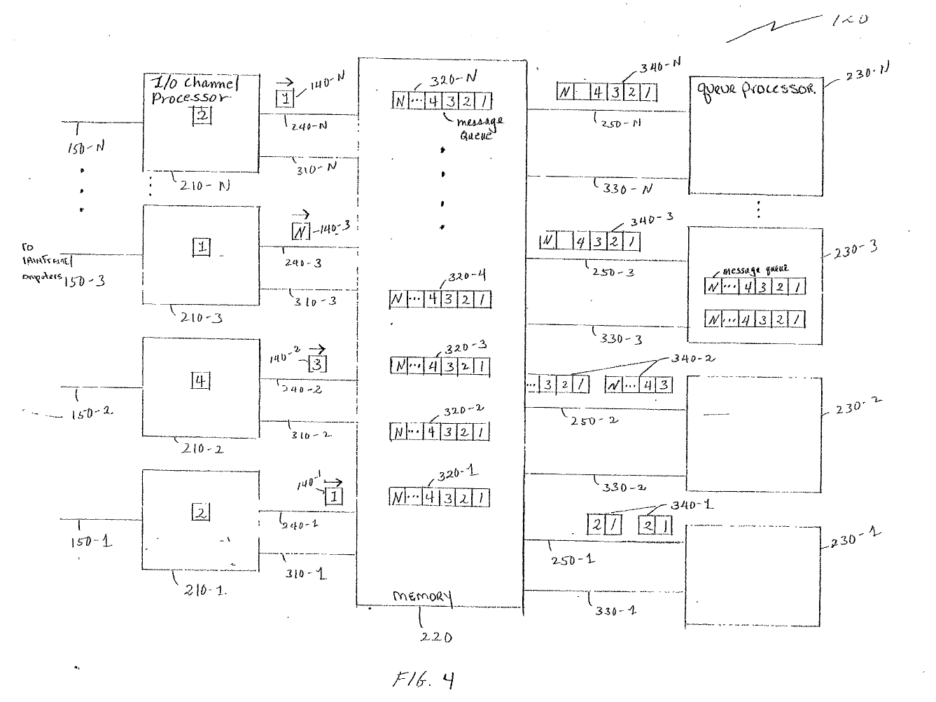

FIG. 4 is a block diagram depicting message transfers among the components of the message transfer unit 120 of FIG. 3. As shown in FIG. 3, the MTU 120 comprises a plurality of I/O channel processors 210, non-volatile memory 220, and a plurality of queue processors 230. The MTU 120 also includes (i) first address/control buses 310-1, 310-2, 310-3, . . . 310-N between the I/O channel processors 210 and non-volatile memory 220, and (ii) second address/control buses 330-1, 330-2, 330-3, . . . 330-N between the non-volatile memory 220 and queue processors 230.

In an outbound message transfer where messages are being transferred from the mainframe to the queue processors 230, each I/O channel processor 210 receives messages from the mainframe using a first data transfer protocol over its fibre optic link 150. In an ESCON communication system, the first data transfer protocol is single message by single message transfer since ESCON channels or fibre optic links operate on a single message by single message basis.

Upon receipt of a message from the mainframe, using the first data transfer protocol, each I/O channel processor transfers the message 140-1, 140-2, . . . 140-N over its first data bus 240 to in the non-volatile memory 220.

The message 140 is stored in the non-volatile memory 220 and subsequently, a positive acknowledgment is returned to the mainframe. When the mainframe receives the positive acknowledgment, the mainframe transfers the next message in the queue to the MTU 120 until all the messages in the queue are stored in the non-volatile memory 220. In other words, the I/O channel processor 210 is not released for another message until the message is properly stored in the memory 220.

As the message 140 from I/O channel processors 210 is stored in the non-volatile memory 220, the non-volatile memory 220 also receives address/control signals over the first address/control bus 310 for the message 140. The message 140 is located and stored according to its address as indicated in the address/control signals. The address/control signals also indicate to which message queue 320 the message 140 belongs and the status of message queue. The messages of a queue 320 are stored one by one in its designated location in the non-volatile memory 220. A message queue 320 is complete when all the messages to be transferred are stored in the queue 320.

As messages are received and stored in the non-volatile memory 220, address/control signals may be sent over the second address/control buses 330-1, 330-2, . . . 330-N to indicate that the messages are ready to be transferred to a messaging middleware queue on at least one queue processor 230. The message are maintained in the non-volatile memory 220 until instructed to be deleted by the mainframe computer or one of the queue processors 230 to ensure message recoverability.

As described above, the non-volatile memory 220 is shareable and may be accessed by queue processors 230. Each queue processor 230 has access to all the message queues 320 in the non-volatile memory 220. At any time, a queue processor 230 may access a message queue 320 and initiate transfer of messages in the queue 320. Similarly, the queue processor 230 may disassociate itself from the message queue 320 and interrupt the transfer of messages. Thus, the non-volatile memory 320 is logically decoupled from the queue processors 230. The queue processors 230 may be brought online and offline at unscheduled times. When a queue processor suddenly goes offline, the status of the queue processor 230, message transfer, message queue 320, and non-volatile memory are stored and maintained in the non-volatile memory 220.

The message queues 320 may be transferred from the non-volatile memory 220 to the queue processors 230 using a second data transfer protocol. The second data transfer protocol may be blocks of message transfers. A block of messages 340 may include up to about 100 messages. However, the block may include only one message. Some blocks of messages may contain a whole queue of messages 340-3 and transferred from the non-volatile memory 220 to the queue processor 230-N. As illustrated certain blocks of messages may 340-1 and 340-2 contain a subset of messages from a message queue, such as a block of two to three messages 340-1 and 340-2, and transferred over the second data bus 250-1. Transferring blocks of messages between the non-volatile memory 220 and queue processors 230 improves the message transfer efficiency. The rate of message transfer resulting from a block transfer may be as much as five times faster than the rate of message transfer when done as single message by single message transfers.

Two or more queue processors 230-1 and 230-2 may access the same message queue 320-1 and transfer different subsets of messages 340-1 and 340-2 in the same message queue 320-1. As shown, the queue processor 230-1 is transferring a subset of messages 340-1, including messages 1 and 2 of the message queue 320-1. Another queue processor 230-2 is transferring a subset of messages 340-2, including messages 3 and 4 of the same message queue 320-1.

It should be understood that in an inbound message transfer, messages are similarly transferred from the queue processor 230 to the mainframe as described above.

Each queue processor 230 may have memory, usually volatile, to store and queue the messages received from the non-volatile memory 220 until they are processed.

When one of the queue processors 230 loses communication with the non-volatile memory and where the queue processors 230 are using a shared bus, another queue processor 230 may recover the status of the messages being transferred. The queue processor 230 is allowed to continue transferring the messages that were interrupted by the loss of communication. For example, if the queue processor 230-1 was transferring a queue of messages 320-1 and loses communication after transferring and processing messages 1 and 2 of the queue 321-1, then another queue processor 320-2 may continue the transfer of the rest of the messages in the queue 320-1.

To determine where to start the continued queue transfer, the queue processor 320-2 checks the state of the message queue 230-1 and the messages being transferred to determine the last message that was properly transferred to the queue processor 320-1. The queue processor 320-2 may also check the state of the queue processor 320-1 as stored in status registers (not shown) in the memory 220, and request transfer of the rest of the messages 3, 4, . . . N of the queue 320-1. The state of the message queue 320-1 is changed in the status registers in the memory 220 so that the queue processor 320-1 is notified of the transfer of messages when it comes back online.

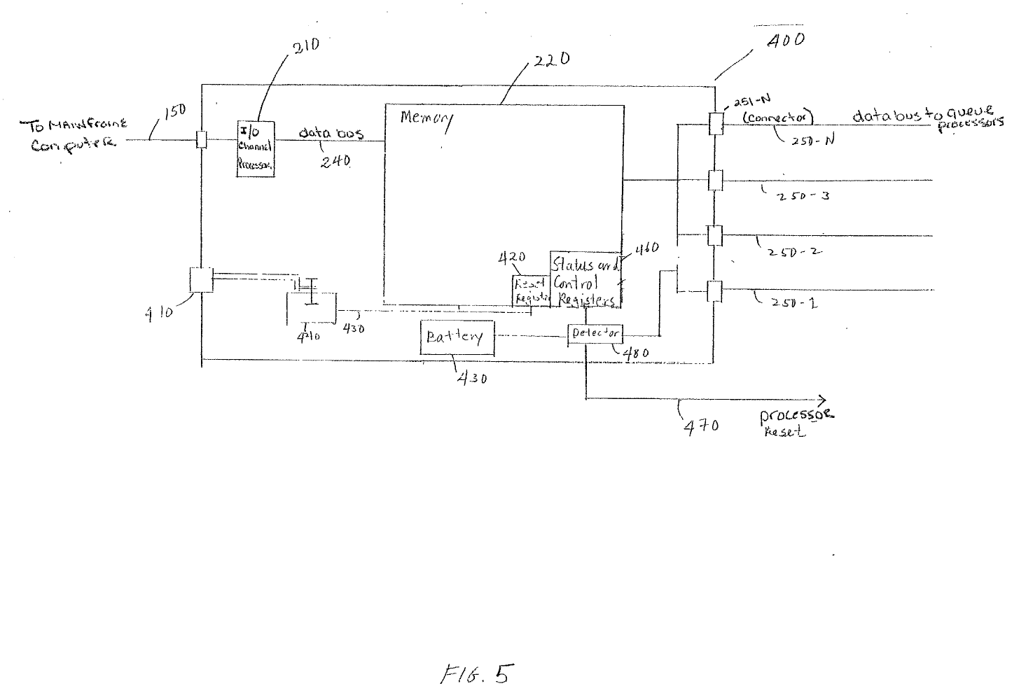

FIG. 5 is a block diagram of an adapter 400 employing the principles of the present invention. The adapter 400 includes an I/O channel processor 210, non-volatile memory 220, reset register 420, status and control registers 460, local power source 430, reset button 410, relay circuit 440, and processor reset detector 480.

The connectors 251 are communication ports on the adapter 400 connecting the non-volatile memory 220 to a plurality of queue processors 230. Each queue processor bus 250 is associated to a connector 251 to access the non-volatile memory 220.

The adapter 400 is resettably decoupled from the I/O channel processors 210 and queue processors 230. The adapter 400 is resettably isolated from the queue processor buses 250-1 to ignore a bus reset and loss of communication from any of the queue processors 230. During a restart or reset of a queue processor 230-1, the relay circuit 440 may be used to isolate the adapter 400 from a second data bus 240-1. Thus, the message queues 230 are preserved in the non-volatile memory 220 during a reset or restart of the queue processor 230.

A programmable interface, such as control registers 460, may permit the adapter 400 to honor a reset signal through a second processor reset line 470 when desired. Similarly, a manual reset button 410 is provided on the MTU 120 to allow manual system reboot along with a full adapter reset.

The state and control structures of the adapter 400, MTU devices, message queues and messages being transferred are maintained in the status and control registers 460 of the non-volatile memory 220. At a power reset or reapplying power, a queue processor 230 begins executing a boot program. The queue processor 230 accesses the status and control registers 460, in which data are stored indicative of (i) the operation and state of the queue processor 230, (ii) the last message being transferred, and (iii) message queues.

A local power source 430, such as a battery 430, preserves the non-volatile memory in the event of a power-off reset or power loss. The battery 430 provides power to the non-volatile memory to maintain message queues 320 and status and control registers 460. The capacity of the local power source 430 is preferably sufficient enough so that power is provided to the non-volatile memory 220 until system power returns.

A processor reset detector 480 determines when a queue processor 230 or I/O channel processor 210 resets. When the detector 480 determines that a queue processor 230 is resetting, then the non-volatile memory 220 is decoupled from second data buses 330 to maintain the messages 320 stored in the memory 220. The state of the non-volatile memory 220, second processors 220, and message queues 320 are retained to ensure message recoverability.

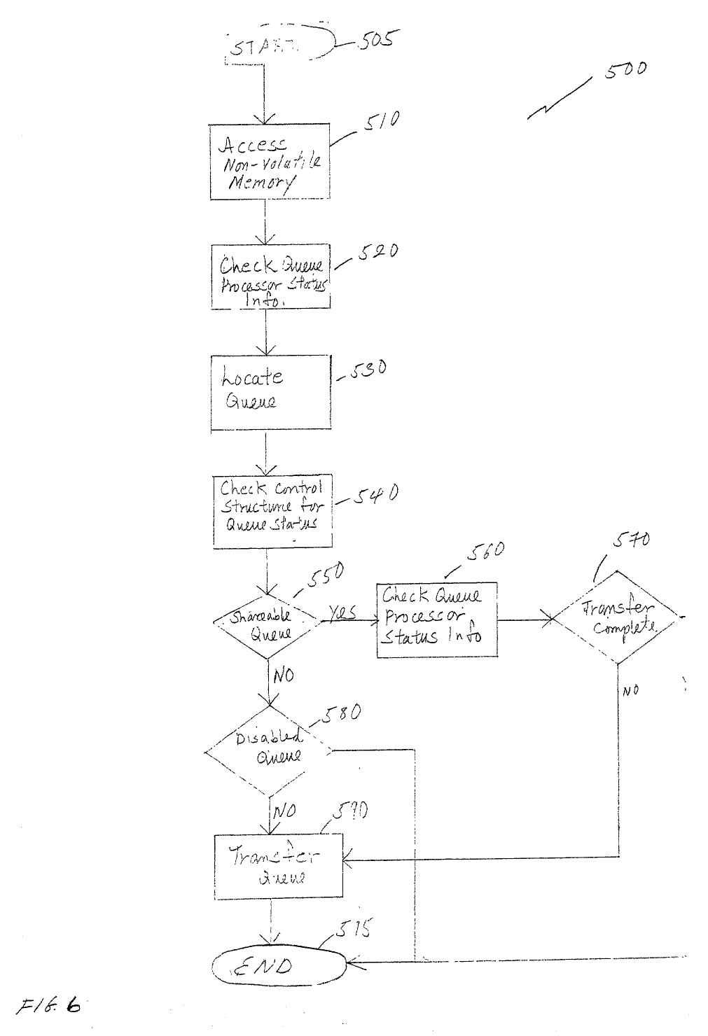

FIG. 6 is a flow diagram of a message recovery process 500 executed by the adapter 400 of FIG. 5. After a reset or reapplying power, in step 510, the queue processors 230 obtain access to the non-volatile memory 220. In step 520, the queue processors 230 read the status and control registers 460 to determine the status of the queue processors 230 and the messages being transferred before the reset or communication loss. The status and control registers 460 also provide the status information of the message queues 320.

In step 530, the queue processor 230 determines the location of the last messages being transferred before the interruption. In step 540, the status of the message queue 320 is checked. In step 550, it is determined whether the message queue 320 is shareable.

If the message queue is shareable, then the message queue status is checked at step 560 to determine whether another queue processor 220 has accessed the message queue during the interruption. In step 570, the queue processor 230 determines whether the transfer of the messages in the queue 320 has been completed. If the transfer is completed, the queue processor starts to transfer the rest of the messages in the message queue 320 at step 590. If so, the transfer of the message queue 320 has been completed by another queue processor and, thus, the message recovery process ends at step 595.

If the message queue is not shareable, then at step 580, the queue processor 230 determines if the message queue 320 is disabled. The message queue 320 may be disabled by the mainframe computer or due to transfer errors. If disabled, then the message queue 320 may not be accessed by the queue processor 230 and the recovery process ends at step 595. If not disabled, the rest of the messages are transferred at step 590. The recovery process ends at step 595.

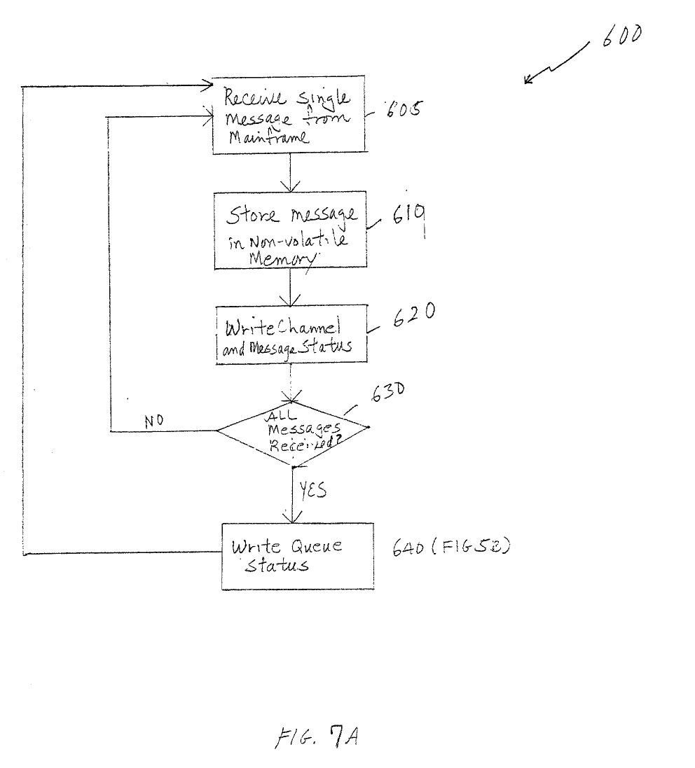

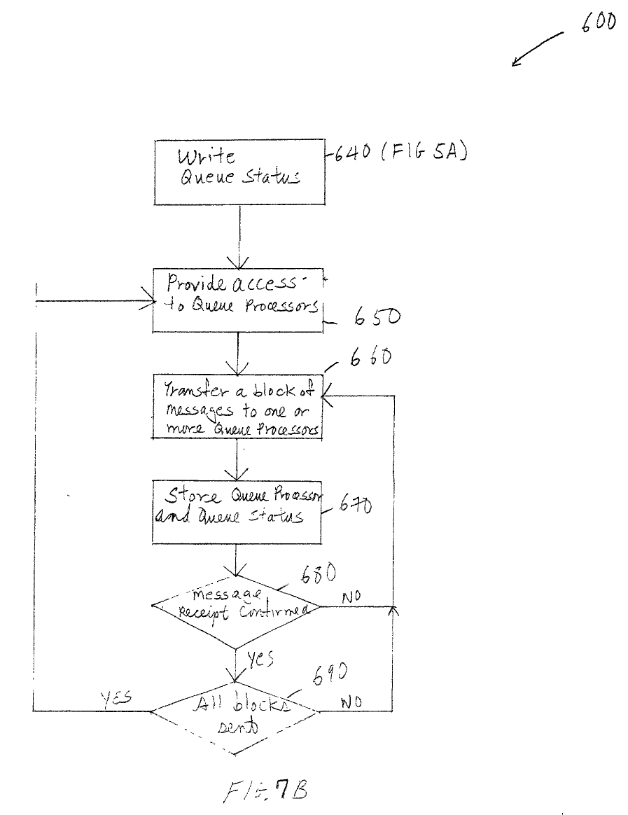

FIGS. 7A and 7B are flow diagrams of a message queue transfer process 600 executed by the system of FIG. 5. In step 605, the I/O channel processor 210 receives a single message from the mainframe computer. In step 610, the message is written to the non-volatile memory 220. In step 620, the I/O channel processor and message status is written to the status and control registers 460. In step 630, the system determines whether all the messages in a message queues have been received. If the messages have been received, the queue status is written to the status and control registers 460. If the messages have not been received, then steps 605 to 620 are repeated until all messages in the queue 320 are stored in the non-volatile memory 220.

In step 650, after all the messages are stored in the non-volatile memory 220, the queue processors 230 may obtain access to the queue. Depending on the status of the queue 320, messages are transferred at step 660 to one or more queue processors 230 using a second data transfer protocol. In step 670, after the transfer of each block of messages, the states of the queue processor and the message queue 320 are written into the status and control registers 460. In step 680, the queue processor confirms the receipt of messages. If all messages have been received, it is determined at step 690 whether all the messages in the queue have been transferred. If all the messages have not been received, steps 660 to 680 are repeated. The queue processor 230 returns to step 650 and repeats steps 650 to 690 to transfer another queue of messages.

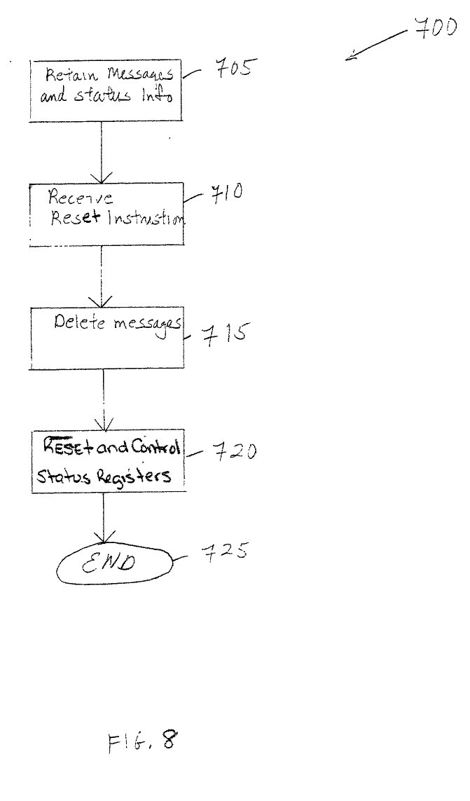

FIG. 8 is a flow diagram of a memory reset process 700 executed by the adapter 400 of FIG. 5. As described above, a memory reset may be initiated by manually pushing the reset button 410 or programmed in the control register. In step 705, the status of the non-volatile memory 220 and queue processors 230 are retained and updated in the status and control registers 460. In step 710, the adapter 400 receives a reset instruction. In step 715, all the messages in the non-volatile memory are deleted. In step 720, the status and control registers 460 are reseted.

It should be understood that the processes of FIGS. 4-6 may be executed by hardware, software, or firmware. In the case of software, a dedicated or non-dedicated processor may be employed by the adapter 400 to execute the software. The software may be stored on and loaded from various types of memory, such as RAM, ROM, or disk. Whichever type of processor is used to execute the process, that processor is coupled to the components shown and described in reference to the various hardware configurations of FIGS. 3-5, so as to be able to execute the processes as described above in reference to FIGS. 6-8.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for transferring messages, comprising:
a first processor using a first data transfer protocol;
a second processor using a second data transfer protocol; and
non-volatile memory in communication with said first and second processors, resettably and logically decoupled from the first and second processors, storing messages being transferred between the first and second processors to ensure message recoverability in the event of a loss of communication between the second processor and the non-volatile memory.

2. The system of claim 1 further comprising a register for storing the state of message transfer between the first and second processors.

3. The system of claim 1 wherein the non-volatile memory ensures message recoverability by reestablishing communication with the second processor without the loss or doubling of messages after a loss of communication.

4. The system of claim 1 wherein the non-volatile memory stores messages in queues.

5. The system of claim 1 further comprising a plurality of second processors in communication with said non-volatile memory, each having independent access to the queues, including the same queues.

6. The system of claim 5 wherein the second processors are brought on-line at unscheduled times.

7. The system of claim 1 wherein the non-volatile memory is resettable independently of the first and second processors.

8. The system of claim 1 further comprising a local power source for providing power to the non-volatile memory to maintain messages stored prior to an interruption in system power.

9. The system of claim 8 wherein the local power source provides power for at least two minutes.

10. The system of claim 8 wherein the local power source provides power for at least 30 seconds.

11. The system of claim 1 wherein the second processor selectively obtains access to the messages in the non-volatile memory.

12. The system of claim 1 wherein the non-volatile memory retains messages after the transfer of messages between the first and second processors.

13. The system of claim 12 wherein the messages are stored in the non-volatile memory until instructed to reset.

14. The system of claim 1 wherein the non-volatile memory improves message transfer efficiency between said first and second processors by storing messages to provide block of message transfers.

15. The system of claim 1 further comprising means for detecting the loss of communication between the second processor and the non-volatile memory.

16. The system of claim 1 wherein the first data transfer protocol executes single message-by-single message transfers.

17. The system of claim 1 wherein the second data transfer protocol executes blocks of message transfers.

18. The system of claim 17 wherein each block includes up to about 100 messages.

19. The system of claim 17 wherein the rate of block message transfer is improved by as much as five times over single message-by-single message transfers.

20. The system of claim 1 wherein the first and second processors and non-volatile memory are on a single computer card attaching to the backplane of a computer.

21. A method for transferring messages between a first and at least one second processor comprising:
using a first data transfer protocol, transferring messages between the first processor and non-volatile memory;
storing the messages in non-volatile memory; and
using a second data transfer protocol, transferring messages between the non-volatile memory and a second processor, the non-volatile memory (a) being resettably and logically decoupled from said first and second processors and (b) ensuring message recoverability in the event of a loss of communication between the second processor and the non-volatile memory.

22. The method according to claim 21, wherein the transferring of messages is done in the reverse order to transfer messages from the second processor to the first processor.

23. The method according to claim 21 wherein the messages in the non-volatile memory are in queues.

24. The method according to claim 21 further including storing the state of transfer of messages between the first and second processors.

25. The method according to claim 21 wherein transferring messages between the second processor and non-volatile memory supports losing communication and reestablishing communication in a manner without the loss or doubling of messages.

26. The method according to claim 25 wherein reestablishing communication includes retrieving message transfer status.

27. The method according to claim 21 wherein transferring messages includes transferring messages between the non-volatile memory and a plurality of second processors.

28. The method according to claim 21 further comprising resetting the non-volatile memory independently of the first and second processors.

29. The method according to claim 21 further comprising providing a local power source to provide power to the non-volatile memory in the event of a power loss.

30. The method according to claim 29 wherein the local power source provides power for at least two minutes.

31. The method according to claim 29 wherein the local power source provides power for at least 30 seconds.

32. The method according to claim 21 wherein transferring messages between the second processor and non-volatile memory includes selectively obtaining access to the messages in the non-volatile memory.

33. The method according to claim 21 wherein storing messages includes retaining messages after the transfer between the first and second processors.

34. The method according to claim 33 wherein storing messages includes storing the messages in the non-volatile memory until instructed to reset.

35. The method according to claim 21 wherein storing messages rather than transferring messages directly between the first and second processors improves message transfer rate for at least one of the processors.

36. The method according to claim 35 wherein storing messages rather than transferring messages directly between the first and second processor improves the message transfer rate by at least a factor of about five .

37. The method according to claim 21 further comprising detecting loss of communication between the second processor and the non-volatile memory.

38. The method according to claim 21 wherein the first data transfer protocol executes single message-by-single message transfers.

39. The method according to claim 21 wherein the second data transfer protocol executes blocks of message transfer s.

40. The method according to claim 21 wherein transferring messages between the second processor and non-volatile memory comprises transferring a queue of messages to one second processor and the same queue to another second processor.

41. An adapter for transferring messages between a mainframe computer and a second processor, comprising:
a first processor using a first message transfer protocol;
non-volatile memory in communication with the mainframe and second processor, resettably and logically decoupled from the mainframe and second processor, storing messages being transferred between the mainframe and second processor to ensure message recoverability in the event of a loss of communication between the second processor and adapter; and
a connector using a second message transfer protocol.

42. The adapter of claim 41 further comprising a local power source for providing power to the non-volatile memory to maintain messages stored prior to an interruption in system power.

43. The adapter of claim 42 wherein the local power source provides power for at least two minutes.

44. The adapter of claim 42 wherein the local power source provides power for at least 30 seconds.

45. The adapter of claim 41 further comprising a register for storing the state of message transfer between the first and second processors.

46. The adapter of claim 41 wherein the non-volatile memory ensures recoverability by reestablishing communication with the second processor without the loss or doubling of messages after a loss of communication.

47. The adapter of claim 41 further comprising a sensor for detecting a loss of communication between the adapter and second processor.

48. The adapter of claim 41 wherein the non-volatile memory stores messages in queues.

49. The adapter of claim 41 wherein the adapter is resettable independently of the mainframe and second processors.

50. The adapter of claim 41 wherein the second processor selectively obtains access to the messages in the non-volatile memory.

51. The adapter of claim 41 wherein the non-volatile memory retains messages after the transfer of messages between the mainframe and second processors.

52. The adapter of claim 41 wherein the messages are stored in the non-volatile memory until instructed to reset.

53. The adapter of claim 41 wherein the adapter improves message transfer efficiency between said first and second processors by storing messages to provide block of message transfers.

54. The adapter of claim 41 wherein the first data transfer protocol executes single message-by-single message transfers.

55. The adapter of claim 41 wherein the second data transfer protocol executes blocks of message transfers.

56. The adapter of claim 55 wherein each block includes up to about 100 messages.

57. The adapter of claim 55 wherein the rate of block message transfer is improved by as much as five times over single message-by-single message transfers.

58. The adapter of claim 41 wherein the adapter is a single computer card attaching to the backplane of a message transfer unit.

59. The adapter of claim 58 wherein the message transfer unit is a message queue server.

60. The adapter of claim 59 wherein the message queue server emulates a tape drive.
